(19) United States
(12) Patent Application Publication
(10) Pub. No.: US 2018/0162757 A1
(43) Pub. Date: Jun. 14, 2018

(54) VENTURI APPARATUS AND METHOD OF USE

(71) Applicant: New Environmental Engineering Inc., San Pedro, CA (US)

(72) Inventor: John Stewart Lang, Los Angeles, CA (US)

(73) Assignee: New Environmental Engineering, Inc., San Pedro, CA (US)

(21) Appl. No.: 15/891,088

(22) Filed: Feb. 7, 2018

Related U.S. Application Data
(63) Continuation-in-part of application No. 15/595,431, filed on May 15, 2017.
(60) Provisional application No. 62/391,924, filed on May 16, 2016.
(60) Provisional application No. 62/498,867, filed on Jan. 10, 2017.
(60) Provisional application No. 62/499,885, filed on Feb. 7, 2017.

(51) Int. Cl. C02F 3/12; C02F 3/20; B01F 3/04

(52) U.S. Cl. CPC C02F 3/1294; C02F 3/1247; B01F 2003/04134; B01F 3/04113; B01F 2003/04865; C02F 3/201

(57) ABSTRACT

The invention comprises an improved venturi apparatus and method of use.

### CROSS-REFERENCE TO RELATED APPLICATIONS

This application is a continuation-in-part of U.S. patent application Ser. No. 15/595,431, filed May 15, 2017, which in turn claims priority to U.S. Provisional Patent Application Ser. No. 62/499,885, filed Feb. 7, 2017, U.S. Provisional Patent Application Ser. No. 62/498,867, filed on Jan. 10, 2017, and U.S. Provisional Patent Application Ser. No. 62/391,924, filed on May 16, 2016. All of the foregoing applications are incorporated herein by reference in their entireties.

### FIELD OF THE INVENTION

The present invention relates to fluid mixers and methods of use, and more particularly, to an improved fluid mixing apparatus in the form of a venturi.

### BACKGROUND OF THE INVENTION

Fluid-mixing systems are conventionally used for various purposes, including aeration.

By way of example, but not limitation, fluid (e.g., gas-liquid) mixing systems are used in wastewater treatment systems. Industrial and municipal wastewater is often treated using biological techniques. Sufficient oxygen must be provided to aerobic organisms in order to carry out a biotreatment process. Most treatment processes therefore include an aeration step.

Aeration serves two important purposes: supplying the required oxygen to the organisms to grow, and providing optimum contact between the dissolved and suspended organic matter and the microorganisms by driving the cross roll current that keeps floc suspended. The aeration system consumes approximately 70 to 80 percent of the net power demand for a typical activated sludge wastewater treatment plant: therefore, the efficiency of different aeration systems is an important consideration. In order to be economically efficient, then, as much oxygen as possible must be dissolved in the wastewater.

Aeration, in part, may be accomplished by pumping air using, e.g., air compressors, through one or more air distribution apparatus or manifolds, to one or more liquid/gas mixing apparatus such as a venturi. In some wastewater systems using venturis, for example, wastewater supernatant is mixed with air to create an air/wastewater mixture, which is then expelled from the venturis into a treatment tank.

A conventional venturi is a device that creates a constriction area within a tube or pipe (usually, formed in an hourglass shape) that varies the flow characteristics of a fluid (either liquid or gas) traveling through the tube. Using Bernoulli's equation, as the fluid velocity in the constriction area of the tube or pipe increases, there is a consequential drop in pressure (as compared to the upstream, non-constricted area). In other words, when a primary fluid flowing through the venturi is forced through a constriction area (e.g., a narrower section in the body of the tube or pipe), pressure decreases and fluid velocity increases. A venturi can use this “negative” pressure to draw a secondary fluid into the venturi to, e.g., mix with the primary fluid flow. The venturi effect was named after Italian physicist, Giovanni Battista Venturi, who lived from 1746-1822.

Many commercial industry applications rely on the venturi effect. For example, carburetors, water aspirators, ship bilges, atomizers, foam firefighting nozzles, and aquarium aerators, all rely on the venturi effect.

Conventional venturi designs and methods of use are known in the art. Generally, such devices usually comprise fittings or tubular structures, and in particular, pipe structures that are constricted in the middle and flared on both ends, as described in, for example, U.S. Pat. Nos. 2,020,850; 3,271,304; 4,210,166; and 7,614,614. Such venturis are often used to mix a first fluid passing through the venturi (e.g., a liquid) with a second fluid (e.g., a gas) passing through the venturi. The constriction point of the venturi creates a vacuum that is operative to draw in the second fluid to mix with the first fluid. The result, in this example, is a liquid/gas mixture that is then expelled from the venturi. Exemplary of such devices that rely on this principle include those disclosed in U.S. Pat. Nos. 5,509,349 and 6,568,660.

Conventional venturi designs have inherent limitations. The constriction point or tapered area of the venturi chokes the primary fluid flow, resulting in back-pressure that can, for example, burden a pump connected to the venturi with unnecessary load. This burden may increase energy costs and shorten the pump's serviceable life. Likewise, because of the limited size of the constriction point or tapered area, the area into which a secondary fluid can be drawn into the fluid flow is necessarily reduced. The combined increased speed of the fluid and reduced area can thus limit the ability of the venturi to efficiently draw in a second fluid. In addition, the venturi effect fluctuates even with slight changes in flow rate, temperature, viscosity and other parameters.

There is therefore a need in the art for an improved venturi apparatus that modifies the desired flow dynamics of the venturi apparatus to consequently improve the ability of the venturi through which a first fluid is flowing to draw in one or more second fluids to create a mixture of the first and second fluids. There is also, given the many commercial applications for such devices, a need in the art for such a venturi apparatus that is of simple construction, low-cost to manufacture or adapt to particular uses, and capable of being readily deployed in a wide-variety of applications. There is yet further need for such an improved venturi that can be readily utilized with a low or high pressurized fluid flow, while at the same time facilitating the mixture of any combination of fluid materials, whether liquid with liquid, gas with liquid, or gas with gas combinations.

### SUMMARY OF THE INVENTION

The invention comprises, in one form thereof, an improved venturi apparatus and method of use.

In another form, the invention comprises an improved venturi apparatus wherein the apparatus' aspiration point is located within the venturi jet barrel and fluid flow is constrained around the aspiration point by the physical walls of the device, allowing the venturi to operate with lower fluid flow rates.

In yet another form, the invention comprises an improved venturi apparatus operative to mix two or more fluids, comprising: a hollow, substantially cylindrical primary tube having a first inlet to admit a first fluid into the primary tube, wherein said first fluid is flowable through the primary tube in a first direction, one or more interior walls, and a mixture exit configured to expel a mixture of two or more fluids, and at least one connection for joining said primary tube to one or more fluid sources; a hollow, substantially cylindrical secondary tube, having an exterior surface, a second inlet to admit a second fluid into the secondary tube, wherein said second fluid is flowable through the secondary tube in a second direction that is not identical to said first direction, an end opposite to said second inlet, a plug disposed on said end, a plurality of perforations through which at least some of said second fluid may flow out of said secondary tube, and at least one connection for joining said secondary tube to one or more fluid sources; one or more constriction channels formed by space(s) between or around the exterior surface of the secondary tube and the interior walls of the primary tube; wherein said primary and secondary tubes are concentric; and wherein said secondary tube is disposed at least in part inside the primary tube.

In a further form, the invention comprises a method of mixing two or more fluids using improved venturi apparatus comprising the steps of: admitting a first fluid through a first inlet of a primary pipe; pumping said first fluid in a downstream direction through a hollow, substantially cylindrical body having one or more interior walls in said primary pipe; admitting a second fluid through a second inlet of a secondary pipe, wherein said secondary pipe is concentrically disposed within said primary pipe; pumping said second fluid in an upstream direction through a hollow, substantially cylindrical body of said secondary pipe sealed by a plug on the end opposite said second inlet; pumping said first fluid through one or more constriction channels formed between said one or more interior walls and an exterior surface of said secondary tube; drawing said second fluid through one or more perforations in said body of said secondary pipe into said one or more constriction channels; mixing the second fluid drawn through said perforations with said first fluid in said constriction channels; pumping said mixture in a downstream direction through said body of said primary pipe; and expelling said mixture through a mixture exit disposed on said primary pipe.

In a further form, the invention comprises a system for treating wastewater, comprising: a) one or more tanks adapted to digest organic materials in wastewater with aerobic micro-organisms, comprising: (i) a liquid distribution apparatus connected to one or more venturis suspended within the one or more tanks, wherein said one or more venturis are adapted to discharge an air/liquid mixture into said one or more tanks, comprising, a first inlet operable to admit a liquid into a primary tube, wherein said liquid is flowable through a primary tube in a first direction; a secondary tube disposed, at least in part, inside the primary tube, wherein said secondary tube comprises perforations located downstream from a plug disposed on or around one end of said secondary pipe to form a substantially gas-tight seal; a second inlet operable to admit a gas into the secondary tube, wherein said gas is flowable through the secondary tube in a second direction; a spider having one or more arms; wherein said perforations permit the passing of said gas out of said secondary pipe and into said primary pipe to mix with said gas to form a liquid/gas mixture; and one or more exits; (ii) an air distribution manifold connected to the one or more venturis suspended within the one or more tanks; b) one or more pumps adapted to pump supernatant through the liquid distribution apparatus; and c) one or more air compressors adapted to pump air to the air distribution manifold.

### BRIEF DESCRIPTION OF THE DRAWINGS

The present invention is disclosed with reference to the accompanying drawings, wherein:

FIG. 1 is a diagram of conventional venturi apparatus according to the prior art;

FIG. 2A is an elevational view of an improved venturi apparatus according to an embodiment of the invention;

FIG. 2B is a longitudinal cross-section view of an improved venturi apparatus according to an embodiment the invention;

FIG. 3 is an end view of an improved venturi apparatus according to an embodiment the invention; and

FIG. 4 is a diagram view of wastewater treatment system including an improved venturi apparatus according to an embodiment of the invention.

Corresponding reference characters indicate corresponding parts throughout the several views. The examples set out herein illustrate several embodiments of the invention but should not be construed as limiting the scope of the invention in any manner.

### DETAILED DESCRIPTION

Referring to FIG. 1, there is shown a conventional venturi apparatus 100 as is currently known in the art. Venturi apparatus 100 comprises primary pipe 101, which in turn has a first pipe portion 110 and a second pipe portion 120. Primary pipe 101 further includes an inlet 102, an exit 103. Venturi apparatus 100 further comprises secondary pipe 104, which is oriented to primary pipe 101 in a “T” configuration. Secondary pipe 104 has an air inlet 130 positioned on the end of secondary pipe 104 furthest from pipe 101. Air inlet 130 is open to the atmosphere. Primary pipe 101 progressively narrows or tapers at the end of first pipe portion 110 to a constriction area 105, and then broadens again before reaching the second pipe portion 120.

Fluid flows through primary pipe 101 in the direction of the arrows, in this view, from left to right. In one example, fluid flows into inlet 102 and through the length of primary pipe 101 along a longitudinal axis. The fluid is ultimately expelled from the primary pipe 101 through exit 103. Because of the venturi effect, the static pressure in the first pipe portion 110 is higher than the pressure in the constriction area 105. The velocity of the fluid in the constriction area 105 increases when compared to the fluid velocity in first pipe portion 110.

More particularly, the cross-sectional area of primary pipe 101 decreases as primary pipe 101 narrows or tapers toward the constriction area 105. In constriction area 105, the fluid velocity must increase to conserve mass continuity and the pressure decreases. As a result of this “negative” pressure, a vacuum is drawn in constriction area 105 near secondary pipe 104. The vacuum causes, in this case, air from the atmosphere to be pulled into air inlet 130, down secondary pipe 104, and into the constriction area 105 of primary pipe 101, where the air mixes with the fluid flowing through primary pipe 101. The air/liquid mixture then flows through second pipe portion 120 and ultimately through exit 103.

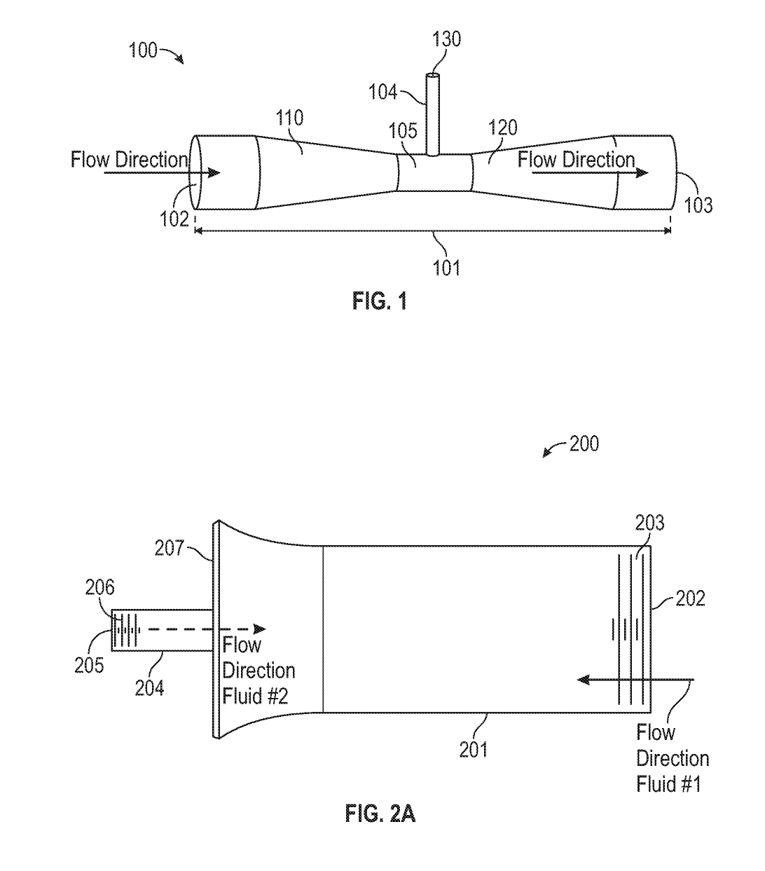

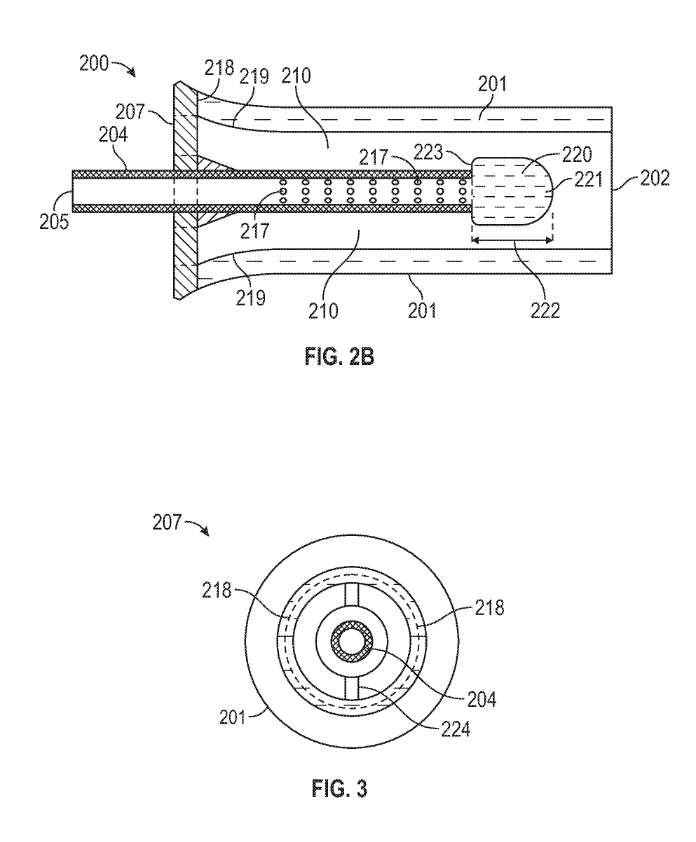

Turning to FIG. 2A, there is shown an elevational view of an improved venturi apparatus 200, which is operative to facilitate the mixture of two or more fluids.

Fluids can comprise any fluid-type substance and encompasses any type of liquid or gas, as well as materials caused to assume either a liquid or gaseous state as may be caused by the application of either heat and/or pressure (e.g., condensates and vaporized or melted materials). In one embodiment, a first fluid comprises a liquid and a second fluid comprises a gas. In another embodiment, a first fluid comprises wastewater and a second fluid comprises ambient air. In yet another embodiment, a first fluid comprises water and a second fluid comprises pumped air.

Improved venturi apparatus 200 comprises a primary tube or pipe 201. Primary tube or pipe 201 may be any desirable shape or size suitable for the venturi's intended application. Primary tube or pipe 201 may be made of extruded or molded plastics, metals, or any suitable material or combination of suitable materials known in the art. In one embodiment, primary tube or pipe 201 comprises a substantially hollow body or housing of a generally cylindrical shape. In another embodiment, primary tube or pipe 201 comprises a main body or housing having one or more inner chambers through which fluid may flow from an inlet of the primary tube or pipe 201 to an exit.

First inlet 202 of primary tube or pipe 201 defines an opening to admit a first fluid (e.g., a liquid) inside the main body or housing of primary tube or pipe 201, or, in another embodiment, into an inner chamber of primary tube or pipe 201. As will be understood by one of ordinary skill in the art, the first fluid may comprise either a single fluid, a plurality of fluids, or a mixture of fluids.

Primary tube or pipe 201 may also include one or more connections 203 for connecting, linking, attaching, or otherwise joining primary tube or pipe 201 (and thereby venturi apparatus 200) directly or indirectly to one or more fluid sources (not shown). In one embodiment, the one or more connections 203 include threading on the outside of primary tube or pipe 201, located near first inlet 202, that is operable to screw venturi apparatus 200 into or onto a fluid source, such as a pipe, hose, tube, or other channel connected directly or indirectly to a liquid pump, or to a liquid pump itself. In this and other embodiments, the one or more connections 203 may include any suitable connection, e.g., a flange, a mechanical joint, or other coupling. One or more connections 203 may further be integral with or separable from primary tube or pipe 201, or disposed inside or on the outside of primary tube or pipe 201. One or more connections 203 need not be immediately adjacent to first inlet 202.

Improved venturi apparatus 200 may further comprise one or more secondary tubes or pipes 204. In one embodiment, secondary tube or pipe 204 is of a generally cylindrical shape. Secondary tube or pipe 204 has, at least in part, a smaller cross-sectional area than that of primary tube or pipe 201, such that a portion of secondary tube or pipe 204 is able to be positioned or disposed within primary tube or pipe 201 without contacting the inner walls of primary tube or pipe 201. Alternatively, in one embodiment, the diameter of secondary tube or pipe 204 at any given point is less than that of primary tube or pipe 204. In one example, the diameter of secondary tube or pipe 204 is ⅛^{th} the smallest diameter of primary tube or pipe 201. Secondary tube or pipe 204 may be any suitable shape or size, so long as it is able to be disposed within primary pipe 201, in at least part, and permits fluid to flow through primary tube or pipe 201 to mix with another fluid exiting secondary tube or pipe 204, and ultimately out of primary tube or pipe 201 through an exit 207.

As shown in FIG. 2B, secondary tube or pipe 204 may be positioned within primary pipe 201 such that constriction areas or channels are formed in the space between at least a part of secondary tube or pipe 204 and a portion of the interior walls of primary tube or pipe 201. In one embodiment, secondary tube or pipe 204 is disposed substantially in the center of primary pipe 201, or substantially equi-distant from the internal walls of primary tube or pipe 201.

In one embodiment, a first fluid flows in a direction shown by the solid arrow in FIG. 2A, right to left, into first inlet 202, then into primary tube or pipe 201 (or a chamber disposed therein), and then into channels created by the spaces between the exterior of secondary tube or pipe 204 and the interior walls of primary tube or pipe 201. Where fluid is flowing from a larger cross-sectional area of primary tube or pipe 201 (or chamber) into the constriction channels (that have a relatively smaller cross-sectional area), static pressure decreases, and fluid velocity increases. Although FIG. 2B shows channels disposed above and below secondary tube or pipe 204 (and below and above the top and bottom interior walls of primary tube or pipe 201), one of ordinary skill in the art will recognize that channels may be formed around all or part of the exterior of secondary tube or pipe 204 depending on the location of the spaces between secondary tube or pipe 204 and the interior walls of primary tube or pipe 201.

In one embodiment, the internal walls of primary tube or pipe 201 are substantially straight along a longitudinal axis from first inlet 202 until at or near mixture exit 207. In another embodiment, as shown in FIG. 2B, the internal walls of primary tube or pipe 201 are substantially straight along a longitudinal axis from at or near first inlet 202 to a point near the mixture exit 207 at which point the interior walls flare away from the axis to create a bell shape on one end of primary tube or pipe 201. In yet another embodiment, the internal walls of primary tube or pipe 201 progressively taper or narrow toward mixture exit 207 to create constriction areas or channels. Constriction areas or channels may be formed such that the average internal cross-sectional area of primary tube or pipe 201 generally progressively decreases in the direction of fluid flow.

Secondary tube or pipe 204 may be made of extruded or molded plastics, metals, or any suitable material or combination of suitable materials known in the art. Secondary tube or pipe 204 may be made of the same or different material as primary tube or pipe 201.

Second inlet 205 is disposed at one end of secondary tube or pipe 204 and defines an opening to admit a second fluid (e.g., a gas) inside the body or housing of secondary tube or pipe 204, or, in another embodiment, into an inner chamber of secondary tube or pipe 204. As will be understood by one of ordinary skill in the art, the second fluid may comprise either a single fluid, a plurality of fluids, or a mixture of fluids. In one embodiment shown in FIG. 2B, the respective inlets 202 and 205 of primary and secondary pipes or tubes 201 and 204 are diametrically opposed. In such an embodiment, the second fluid initially flows in the direction of the dashed arrow shown ion FIG. 2A from left-to-right. In another embodiment, the second fluid initially flows in a different direction (e.g., perpendicular to, or diagonal to) than that of the first fluid. For example, as shown in FIG. 2B, the second fluid flows in a direction (right-to-left along a longitudinal axis) substantially opposite to the direction of flow of the first fluid (left-to-right along the same axis). As will be understood by one of ordinary skill in the art, the second fluid may comprise a single fluid, a plurality of fluids, or a mixture of fluids.

As shown in FIG. 2A, secondary tube or pipe 204 may also include one or more connections 206 for connecting, linking, attaching, or otherwise joining secondary tube or pipe 204 (and thereby venturi apparatus 200) directly or indirectly to one or more fluid sources (not shown). For example, such a fluid source may include pipe, hose, tube, or other channel connected directly or indirectly to an air compressor or pump, or the ambient air. In one embodiment, the one or more connections 206 include threading on the outside of secondary tube or pipe 204, on or near second inlet 205, that is operable to screw secondary tube or pipe 204 into or onto a fluid source. In other embodiments, the one or more connections 206 may include any suitable connection, e.g., a flange, a mechanical joint, or other coupling on the inside or outside of secondary tube or pipe 204. The one or more connections 206 may be integral with or separable from secondary tube or pipe 204, or disposed inside or outside secondary tube or pipe 204. One or more connections 206 need not be immediately adjacent to second inlet 205.

As shown in FIG. 2B, a portion of secondary tube or pipe 204 is perforated by, e.g., holes or other perforations 217. Holes 217 may be any suitable shape and size, and may be disposed on any suitable portion of secondary tube or pipe 204 such that the second fluid (e.g., a gas) flowing through secondary tube or pipe 204 may exit or pass out of secondary tube or pipe 204 through holes 217 and into primary tube or pipe 201 at a location referred as venturi section 210, which comprises channels that constrict the first fluid flow. In one example, a first fluid enters first inlet 202 and flows through primary tube or pipe 201 passing around secondary tube or pipe 204 and into construction channels. A gas enters secondary tube or pipe 204 and flows through it, as shown, in a direction left-to right. Due to the vacuum created by the “negative” pressure in venturi section 210, which comprises the constriction channels, gas bubbles are drawn out of secondary tube or pipe 204 through holes 217 into venturi section 210. There, the gas mixes with the first fluid to create a first/second fluid mixture. In this example, a gas/liquid mixture is created and then the mixture flows through the remainder of venturi section 210 (including, in one embodiment, through flared channel(s) 219 and past spider or spacer 218) to ultimately be discharged through mixture exit 207. A fairing or other structure suitable structure to increase streamlining and reduce drag may be placed around secondary tube or pipe 204, as indicated by the cross-hatching on FIG. 2B, which is disposed adjacent to the conjunction of secondary tube or pipe 204 and spider 218.

In one embodiment, spider or spacer 218 is disposed on or around, or affixed to, or formed integrally with, primary tube or pipe 201 at a location at or near mixture exit 207. Spider or spacer 218 is configured to support a conduit disposed within primary tube or pipe 201 such that fluid is able to flow through primary tube or pipe 201 and exit through mixture exit 207. Spider or spacer 218 may be configured to allow smooth installation of secondary tube or pipe 204 while maintaining the concentricity of the primary and secondary pipes during use. In one embodiment, spider or spacer 218 comprises spider legs that are affixed to, made integral with, or otherwise support secondary tube or pipe 204 within primary tube or pipe 201. Spider or spacer 218 may be made of any suitable, non-dissolvable material of sufficient strength to support the load of the conduit(s) it is supporting. For example, spider or spacer 218 may be made of epoxy, steel or polymer material, or any combination of suitable materials.

In one exemplary embodiment, primary tube or pipe 201 is a substantially hollow tube, having a substantially cylindrical shape, that terminates at one end in a conic section including spider or spacer 218 and mixture exit 207. In this embodiment, spider or spacer 218 supports secondary tube or pipe 204, which is a substantially hollow, partially-perforated tube with a substantially cylindrical shape concentrically located within primary tube or pipe 201. (Primary tube or pipe 201 and secondary tube or pipe 204 may have any suitable shape and geometry, and need not be circular, in other embodiments.) In alternate embodiments, primary tube or pipe 201 terminates at one end in a flare or bell shape such that as fluid flows in the direction of mixture exit 207, the cross-sectional diameter of primary tube or pipe 201 steadily increases (e.g., flares). Thus, the maximum cross-sectional diameter of primary tube or pipe 201 is highest at or near mixture exit 207.

Turning back to FIG. 2B, secondary tube or pipe 204 may further include a plug, 220. Plug 220 may be made of any suitable, non-dissolvable, substantially solid material of sufficient strength to withstand the hydrodynamic forces acting on the plug 220 by fluid flowing past or around it through primary tube or pipe 201. For example, plug 220 made be made of stainless steel.

Plug 220 is attached to, or disposed on or around, the end of secondary tube or pipe 204 disposed inside primary tube or pipe 201. In one embodiment, plug 220 creates a substantially fluid-tight or gas-tight seal on secondary tube or pipe 204. The portion of plug 220 nearest first inlet 202, shown as plug end 221, may be shaped as a dome, semi-circle, wedge, or any other suitable shape such that fluid flowing through primary tube or pipe 201 is directed into constriction channels located in the space between the exterior of secondary tube or pipe 204 and the interior walls of primary tube or pipe 201. In one embodiment, plug end 221 is a dome shape. Plug 220, as shown in FIG. 2B, is a right-facing domed, solid cylinder, concentric to the inside walls of primary tube or pipe 201. The length of plug 220 in the longitudinal direction, shown as 222, may be any suitable length. The portion of plug 220 attached to, or disposed on or around, the end of secondary tube or pipe 204, opposite to plug end 221, is flat with chamfered corners 223.

As shown, the outer circumference of plug 220 is greater than the circumference of the end of secondary tube or pipe 204. In an alternate embodiment, when viewed in cross-section, plug 220 may optionally have an outer circumference that is less than the inner circumference of primary tube or pipe 201, but equal to or greater than the circumference of the end of secondary tube or pipe 204. In another embodiment, the circumference of the plug 220 may be smaller than that of the end of secondary tube or pipe 204, so long as additional suitable material is used to create a fluid-tight seal on that end of secondary tube or pipe 204.

Turning to FIG. 3, a spider 218 according to one embodiment is shown attached to mixture exit 207. Spider 218 comprises arms 224. Spider arm 224 may be shaped or configured in any suitable way known in the art so as to reduce the hydrodynamic drag of mixture flow through spaces between the spider arms.

Although reference is made to “first” and “second” or “primary” and “secondary” tubes or pipes, inlets, fluids, etc., such labels are provided for convenience only. It is contemplated that the improved venturi 200 of the invention may comprise one, two, three or more tubes or pipes, inlets, exits, connections, fluids, or other elements, which together are operable to mix one, two, three, or more fluids. In one embodiment, for example, secondary and tertiary pipes or tubes are disposed in part within primary tube or pipe 201 such that the fluid flowing through primary tube or pipe 201 may be mixed with a second and third fluid flowing through and exiting secondary and tertiary pipes or tubes.

In practice, when a fluid flows (e.g., a liquid is pumped) through improved venturi apparatus 200, the smaller area or channels restricting fluid flow between plug 220 and secondary tube or pipe 204, and the interior walls of primary tube or pipe 201, result in the venturi effect, where the fluid flow increases in velocity toward mixture exit 207 and static pressure inside improved venturi apparatus 200 is reduced in venturi section 210, downstream of plug 220. The reduced pressure facilitates the introduction of a second fluid (e.g., a gas), which is pulled by a vacuum force through holes 217 into the fluid flowing through the venturi section 210 of primary tube or pipe 201. Additionally, the shear forces created by turbulent flow in venturi section 210 also acts to reduce the average size of the bubble size distribution in any resulting mixture, thereby facilitating aeration.

In an alternate embodiment, the diameter of any cross-section of plug 220 is greater than the diameter of a cross-section of one end of secondary tube or pipe 204, and the radius of chamfer 223 is greater than zero. In such circumstances, the Coanda effect (the phenomena in which a jet flow attaches itself to a nearby surface and remains attached even when the surface curves away from the initial jet direction) causes the fluid flow to attach to plug 220 and be directed towards secondary tube or pipe 204, increasing hydrodynamic shear in the vicinity of holes 217. As a result, the average size of the bubble size distribution in the fluid mixture is reduced, and aeration is facilitated.

In the example described below, such small bubble size distribution is advantageous in gas to liquid mass transfer in wastewater treatment plant aeration tanks.

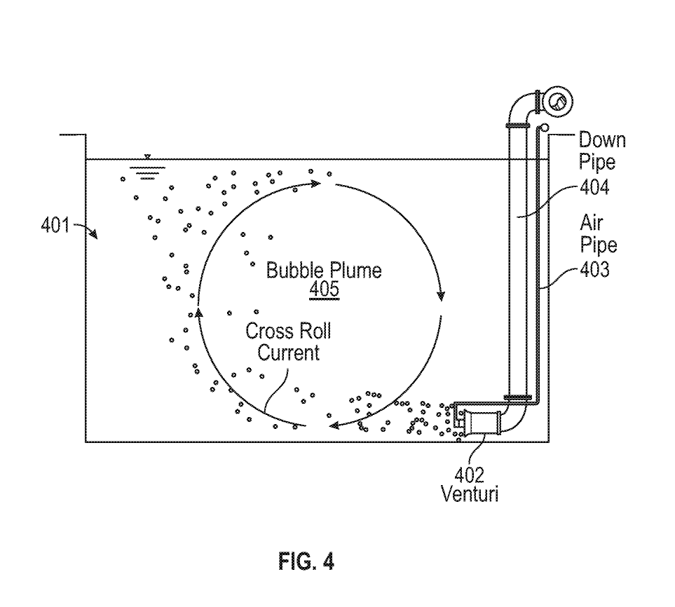

Turning to FIG. 4, a portion of a wastewater treatment plant is shown, particularly exemplary aeration tank 401 employing an improved venturi apparatus 402 according to the invention is shown. Conventional wastewater treatment processes, as known in the art, consist of a combination of physical, chemical, and biological processes and operations to remove solids, organic matter, nutrients, and/or pollutants from wastewater.

A suitable air compression device such as air compressor (not shown) pressurizes air and sends it through air pipe 403 or any other suitable means (e.g., down pipes, or air pipes), to venturi 402, where the air flows through the secondary pipe or tube, exits through perforations in the secondary pipe or tube into the primary tube or pipe, and mixes with another fluid (e.g., a liquid) flowing through the primary tube or pipe. The air/liquid mixture is expelled from the primary tube or pipe of the venturi into an aeration tank 401. The discharge of the mixture at high velocity by venturi 402 both mixes and aerates the wastewater undergoing secondary treatment in the tank.

The air compressor, in one embodiment, pressurizes atmospheric air. The air compressor may include a motor, a vent whereby atmospheric air is drawn in, and a conduit to conduct the air. In another embodiment, venturi 402 is connected to air pipe 403, which is exposed directly or indirectly to ambient air (e.g., above the surface of a fluid in the tank). A vacuum created by a fluid flowing through the primary tube or pipe of venturi 402 draws air down into air pipe 403 and through the secondary tube or pipe of venturi 402. More fluid flow through venturi 402 is required to cause the venturi 402 to aspirate atmospheric air, as compared to where air is pumped into venturi 402 by, e.g., an air compressor.

Venturi 402 may further be in fluid connection with a fluid (e.g., liquid) pump (not shown). In one embodiment, a liquid is pumped through down pipe 404 to venturi 402 where it flows through the primary tube or pipe of venturi 402. Venturi 402 is connected to down pipe 404 by any means suitable in the art. e.g., a flange, a mechanical joint, or other coupling.

Pumping fluids, whether gas or liquid, is more energy and cost efficient than relying on the venturi effect vacuum force to aspirate atmospheric air down the air pipe 403.

Venturi 402 may be optionally in fluid connection with a manifold that serves compressed air from an air compressor to one or more air pipes 403, submerged in aeration tank 401. Venturi 402 may be connected to air pipes 403 (or any intermediate pipes) by any means suitable in the art, e.g., a flange, a mechanical joint, or other coupling. The location of the venturi 402 may be in any suitable place in the aeration tank 401, and in one embodiment, may be adjusted by adjusting, e.g., the length of air pipe 403.

As one of skill in the art will appreciate, venturi 402 can be used with any compatible fluid, e.g., wastewater undergoing secondary treatment, secondary-treated wastewater, potable water, or other liquid, alone or in combination.

The hydraulic shear force created by the air and liquid flowing through venturi 402 produces micro air bubbles (>1 mm diameter) that, when discharged by venturi 402 into aeration tank 401, moves through the tank, transferring oxygen into the wastewater undergoing treatment.

In one embodiment, a bubble plume 405 may rise from each venturi 404. As the concentration of air inside the bubbles is greater than that in the sewage outside of the bubbles, air passes through the gas-liquid interface of the bubbles, from the bubbles into the sewage. The buoyancy of the bubble plume 405 may create a cross roll current in the aeration tank 401. This cross roll current suspends agglomerated aerobic bacteria or microbes in the wastewater, which otherwise would settle to the bottom of the tank 406, where they would not serve their purpose. In another embodiment, a cross roll is produced by the gas/liquid mixture emerging from venturi 402 that flows down-stream through the aeration tank 401. Because the gas/liquid mixture is injected into the tank with a high turbulence, the tank contents are intermixed, which prevent undesired deposits on the tank floor. In aeration tanks that are common in large wastewater treatment facilities (e.g., plug flow reactors) the spiral current is a natural product of the cross roll and the forward motion of mixed liquor through the aeration tank. This current is necessary for proper operation. Without the current, floc would settle to the bottom of the tanks and treatment would stop. In the aeration tank 401, the primary-treated wastewater is acted upon by microbes, e.g., bacteria, which digest organic matter in the wastewater.

As will be apparent to one of ordinary skill in the art, the use of venturis in a wastewater treatment system as described will decrease energy usage as compared to conventional systems. Additional energy savings is attained by using small bubbles in the process rather than the large bubbles, as is used in common practice, to improve air transfer efficiency. Conventionally, the treatment process used large bubbles to avoid clogging underwater air diffusion devices, such as a coarse bubble air diffuser. Venturis, in contrast, produce small bubbles by dint of the strong hydraulic shear that occurs within the devices. Generally speaking, venturis are less likely to clog than currently utilized air diffusers because they have large bore orifices.

In alternative embodiments, existing wastewater treatment plants are retrofitted with the improved venturi apparatus the present invention.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

I claim:

1. An improved venturi apparatus operative to mix two or more fluids, comprising:
a hollow, substantially cylindrical primary tube having a first inlet to admit a first fluid into the primary tube, wherein said first fluid is flowable through the primary tube in a first direction, one or more interior walls, and a mixture exit configured to expel a mixture of two or more fluids, and at least one connection for joining said primary tube to one or more fluid sources;
a hollow, substantially cylindrical secondary tube, having an exterior surface, a second inlet to admit a second fluid into the secondary tube, wherein said second fluid is flowable through the secondary tube in a second direction that is not identical to said first direction, an end opposite to said second inlet, a plug disposed on said end, a plurality of perforations through which at least some of said second fluid may flow out of said secondary tube, and at least one connection for joining said secondary tube to one or more fluid sources;
one or more constriction channels formed by space(s) between or around the exterior surface of the secondary tube and the interior walls of the primary tube;
wherein said primary and secondary tubes are concentric; and
wherein said secondary tube is disposed at least in part inside the primary tube.

2. The apparatus of claim 1, further comprising one or more spiders to support said secondary tube.

3. The apparatus of claim 1, wherein the smallest exterior circumference of said plug is greater than the largest circumference of said secondary pipe.

4. A method of mixing two or more fluids using improved venturi apparatus comprising the steps of:
admitting a first fluid through a first inlet of a primary pipe;
pumping said first fluid in a downstream direction through a hollow, substantially cylindrical body having one or more interior walls in said primary pipe;
admitting a second fluid through a second inlet of a secondary pipe, wherein said secondary pipe is concentrically disposed within said primary pipe;
pumping said second fluid in an upstream direction through a hollow, substantially cylindrical body of said secondary pipe sealed by a plug on the end opposite said second inlet;
pumping said first fluid through one or more constriction channels formed between said one or more interior walls and an exterior surface of said secondary tube;
drawing said second fluid through one or more perforations in said body of said secondary pipe into said one or more constriction channels;
mixing the second fluid drawn through said perforations with said first fluid in said constriction channels;
pumping said mixture in a downstream direction through said body of said primary pipe;
expelling said mixture through a mixture exit disposed on said primary pipe.

5. A treatment system for treating wastewater, comprising:
a) one or more tanks adapted to digest organic materials in wastewater with aerobic micro-organisms, comprising:
(i) a liquid distribution apparatus in fluid connection with one or more venturis suspended within the one or more tanks, wherein said one or more venturis are adapted to discharge an air/liquid mixture into said one or more tanks and include,
a first inlet operable to admit a liquid into a primary tube, wherein said liquid is flowable through a primary tube in a first direction;
a primary tube;
a secondary tube disposed, at least in part, inside the primary tube to be substantially concentric with said primary tube, wherein said secondary tube comprises perforations, wherein said perforations permit the passing of said gas out of said secondary pipe and into said primary pipe where said liquid mixes with said gas to form a liquid/gas mixture;
a second inlet operable to admit a gas into the secondary tube, wherein said gas is flowable through the secondary tube in a second direction, wherein said second direction is substantially the opposite of said first direction;
a spider having one or more arms:
a plug disposed on or around one end of said secondary pipe to form a substantially gas-tight seal; and
one or more mixture exits;
(ii) an air distribution manifold in fluid connection with the one or more venturis suspended within the one or more tanks;
b) one or more pumps adapted to pump supernatant through the liquid distribution apparatus; and
c) one or more air compressors adapted to pump air to the air distribution manifold.

6. The system of claim 5, wherein the one of more tanks comprise at least one of a plug flow reactor, mixed flow reactor, continuously-stirred reactor, or a combination of any of these.

7. A method for aerating wastewater with an improved venturi apparatus, comprising the steps of:
a) pumping wastewater to a treatment tank where aerobic micro-organisms digest organic materials, wherein said treatment tank comprises:
(i) one or more venturis suspended within the treatment tank adapted to discharge an air/liquid mixture into said treatment tank, having,
a first inlet operable to admit a liquid into a primary tube, wherein said liquid is flowable through a primary tube in a first direction;
a secondary tube disposed, at least in part, inside the primary tube, wherein said secondary tube comprises perforations wherein said perforations permit the passing of said gas out of said secondary pipe in order to form a liquid/gas mixture are located downstream (in the first direction) from a plug disposed on or around one end of said secondary pipe to form a substantially gas-tight seal;
a second inlet operable to admit a gas into the secondary tube, wherein said gas is flowable through the secondary tube in a second direction that is substantially opposite of said first direction;
a spider having one or more spider arms;
a plug; and
one or more mixture exits;
(ii) an air distribution apparatus in fluid connection with the one or more venturis suspended within the treatment tank;
c) conveying wastewater from the treatment tank through a liquid distribution apparatus to and through the primary pipe of said one or more venturis;
d) conveying air through an air distribution apparatus to and through the secondary pipe of said one or more venturis;
e) mixing the wastewater and the air in the one or more venturis to create a wastewater/air mixture;
f) expelling the wastewater/air mixture from the one or more venturis into the treatment tank.

8. The method of claim 7, wherein the air distribution apparatus is connected to one or more air pipes.

9. The method of claim 7, wherein the liquid distribution apparatus is connected to a pump.

10. The method of claim 7, wherein the air distribution apparatus is connected to an air pump.

11. An improved venturi apparatus, comprising:
a hollow, substantially cylindrical primary tube having
a first inlet to admit a first fluid into the primary tube, wherein said first fluid is flowable through the primary tube in a first direction,
one or more interior walls, wherein said interior walls are substantially straight in a longitudinal direction,
a mixture exit configured to expel a mixture of two or more fluids,
at least one connection for joining said primary tube to one or more fluid sources;
a hollow, substantially cylindrical secondary tube, having
an exterior surface that is substantially straight in a longitudinal direction,
a second inlet to admit a second fluid into the secondary tube, wherein said second fluid is flowable through the secondary tube in a second direction that is not identical to said first direction,
an end opposite to said second inlet,
a substantially solid plug disposed on said end having one or more chamfered corners,
a plurality of perforations located downstream from said plug through which at least some of said second fluid may be drawn out of said secondary tube, and
at least one connection for joining said secondary tube to one or more fluid sources;
one or more constriction channels;
wherein said secondary tube is disposed at least in part inside said primary tube and is supported by a spider having one or more spider arms, and further wherein said spider is located downstream from said plug.

12. The apparatus of claim 11, wherein the walls of said primary tube flare such that the portion of said primary tube located at said mixture exit has a higher cross section diameter value than the cross section diameter value of any other point of said primary tube.
